(19) United States
(12) Patent Application Publication
(10) Pub. No.: US 2014/0352418 A1
(43) Pub. Date: Dec. 4, 2014

(54) METHOD AND SPECIMEN FOR TESTING BRAKING IN TIRES

(71) Applicant: E I DU PONT DE NEMOURS AND COMPANY, Wilmington, DE (US)

(72) Inventors: MARK ALLAN LAMONTIA, Landenberg, PA (US); William Herbert Coulter, Wilmington, DE (US)

(73) Assignee: E I DU PONT DE NEMOURS AND COMPANY, Wilmington, DE (US)

(21) Appl. No.: 14/267,094

(22) Filed: May 1, 2014

Related U.S. Application Data
(60) Provisional application No. 61/829,400, filed on May 31, 2013.

(51) Int. Cl. G01M 17/02

(52) U.S. Cl. CPC G01M 17/02
USPC 73/146

(57) ABSTRACT

A subscale test cylinder for testing tire performance characteristics, wherein the cylinder comprises components found in a tire sidewall to be simulated, wherein the components consist of cords, sidewall compounds and beads.

### BACKGROUND OF THE INVENTION

1. Field of the Invention

This invention is directed to a method for testing tire properties using a subscale specimen.

2. Description of the Related Art

When a vehicle is traveling at a constant velocity there is no difference in the angular velocity between the rim and the tread of a tire mounted on the rim. However, when the vehicle brakes or accelerates there is a difference between the rim and tire tread angular velocities. Specifically, during braking, the rim angular velocity is less than the tire tread angular velocity; whereas, during acceleration the rim angular velocity exceeds the tire tread angular velocity. This difference in angular velocity causes tire sidewall twisting, specifically tire sidewall distortion in the meridinal-circumferential plane. The tire sidewall's resistance to meridinal-circumferential distortion influences the tire's braking and acceleration performance. Therefore, tire designers try to increase the sidewall meridinal-circumferential stiffness to maximize tire performance.

### BRIEF DESCRIPTION OF THE DRAWINGS

FIG. 1 shows the test cylinder cross-section.

FIG. 2 schematically depicts the test cylinder in a testing apparatus.

FIG. 3 shows a buckled test cylinder.

FIGS. 4 A-C show data signals for torque, vertical displacement and angular displacement at a constant load.

FIGS. 5 A-C show data signals for torque, vertical displacement, and angular displacement at a constant angular motion.

FIG. 6 shows data from cylinders representing different types of tire construction.

### DETAILED DESCRIPTION OF THE INVENTION

A test apparatus and method have been developed using a cylindrical laminate (hereafter, test cylinder or cylinder) that provides similar construction as real, full-sized tires. The invention is a test on a subscale reinforced rubber composite cylinder to assess and predict a full-sized tire's braking (and also acceleration) behavior. The cylinder is formed from general reinforced rubber composite plies, prototype reinforced rubber composite plies, and/or the actual treatments used in manufacturing a tire.

One object is to use these cylinders as surrogates to a full-sized tire to measure how different carcass constructions or ply cords could influence tire performance and, in particular, the meridinal-circumferential stiffness of a tire laminate once fabricated into a tire. This cylinder test is, thus, valuable to i) allow evaluation of many candidate tire materials, ii) elucidate the physical mechanism affecting braking (or acceleration), and iii) lower the cost of tire development. Building tires for testing is costly and, in addition, testing full-sized tires does not alone indicate the contribution of a specific physical mechanism with respect to acceleration and braking performance. The cylinder test is less expensive and isolates physical mechanisms.

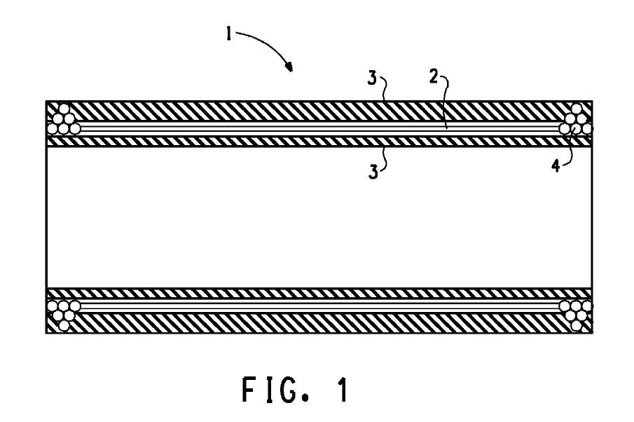

The cylinder 1 can be made with three major components, cords 2, sidewall compound 3, and beads 4 substantially as shown by a longitudinal cross-section in FIG. 1. The meridinal-circumferential plane of the tire carcass is simulated by the axial-circumferential plane of the cylinder. The carcass cords are anchored to the bead by either wrapping the cords around the bead in a manner similar to a tire or to sandwich the cords between two halves of the bead. The cylinder length is 9.00 inches. The inner cylinder diameter is 5.25 inches. The cylinder length and outside diameter varies depending upon the type of tire being simulated and may have an inner diameter in the range of 3-30 inches and a length in the range of 5-60 inches. These dimensions are not fixed and can be made to be consistent with the testing equipment or tire size, or both.

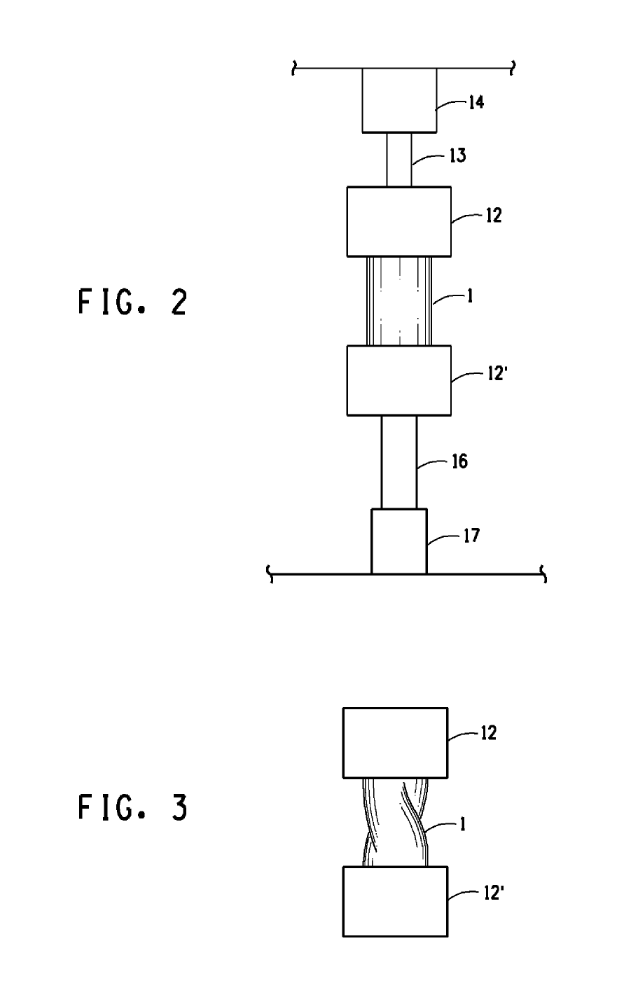

FIG. 2 schematically shows the cylinder 1 mounted in a test apparatus 10 ready for testing. The subject apparatus is an INSTRON® Model 1321, but any similar test machine capable of simultaneously applying vertical and twisting motions can be used. The cylinder is held in place by upper and lower grip assemblies 12 and 12′, respectively.

The grip assemblies consist of three pieces and are described in greater detail, but for the sake of convenience, are not shown in the figures. A base consists of a cylindrical receptacle onto which cylinder 1 is mounted. The receptacle surface is typically bead blasted to better promote adhesion with the rubber cylinder. The base also has a large disk with holes that allows the user to pull a tapered collar around a split tapered ring. The ring has a groove cut into the inside edge to accept the bead portion of cylinder 1. The ring outside edge is tapered to match the tapered collar such that as the collar is pulled up on the rings, they are squeezed together holding the cylinder against the base. Next, a tapered collar is placed over the split tapered ring and threaded rods are passed through the holes in the base and nuts are used to “jack” the collar into place. As the collar is moved toward the base, the split ring is squeezed together gripping the cylinder. The cylinder bead is captured in the split ring groove assuring the cylinder will not slip out.

The test is conducted with reference to FIG. 2, wherein mechanical coupling 13 attaches upper grip assembly 12 to a multi-axis load cell 14 that simultaneously measures tensile loads and twisting moments. A similar coupling 16 is used to attach lower grip assembly 12′ to a multi-axis hydraulic actuator 17 that is capable of simultaneously providing vertical motion and a twisting motion. There are transducers (not shown) for monitoring the actuator vertical displacement and angular motion. By fixing the upper end of the cylinder while rotating its lower end, the cylinder replicates the motion of the tire sidewall which occurs during braking or acceleration. In particular, the cylinder circumferential twisting in the axial-circumferential plane reliably matches a tire's meridinal/circumferential distortion that results from the rim/tread band circumferential velocity difference.

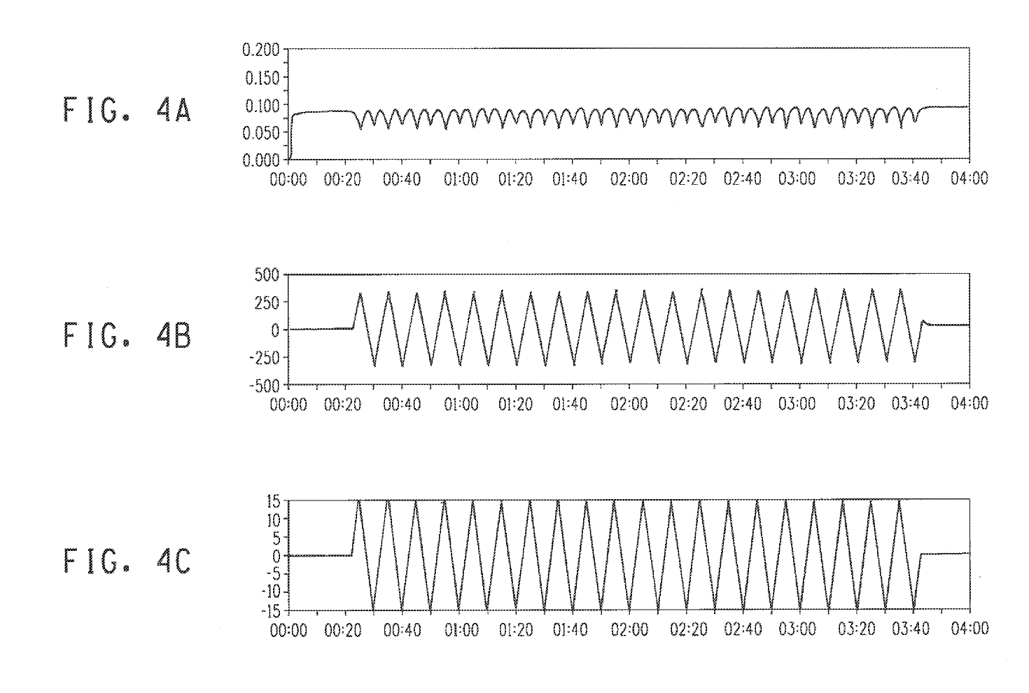

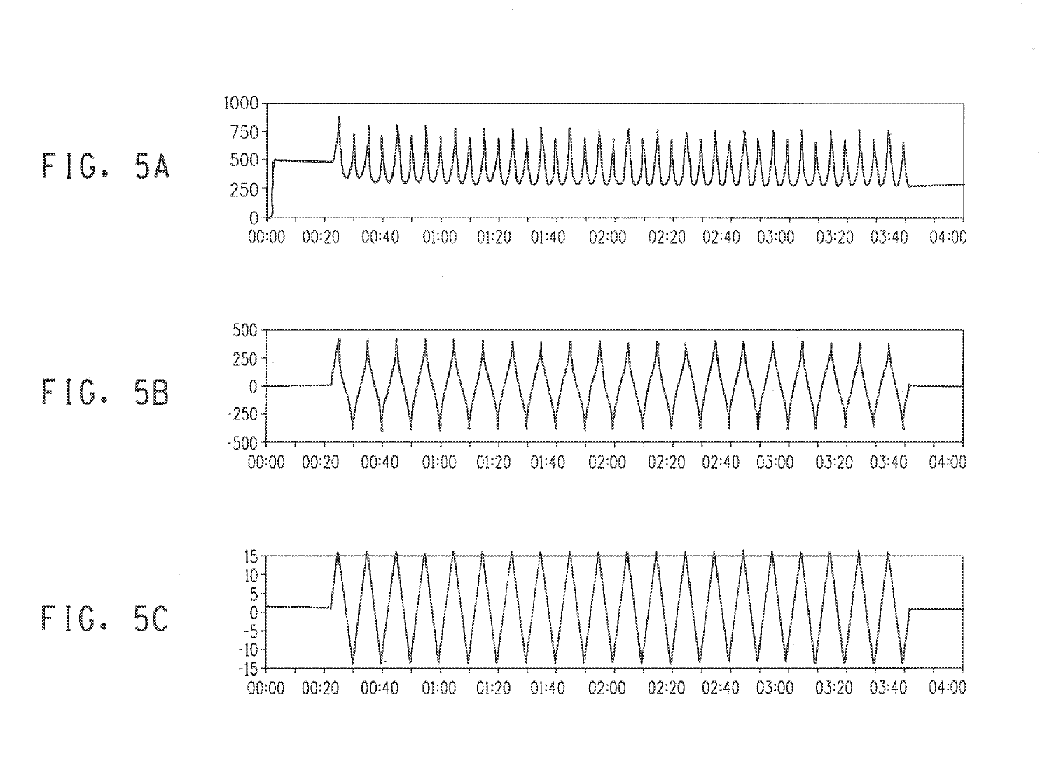

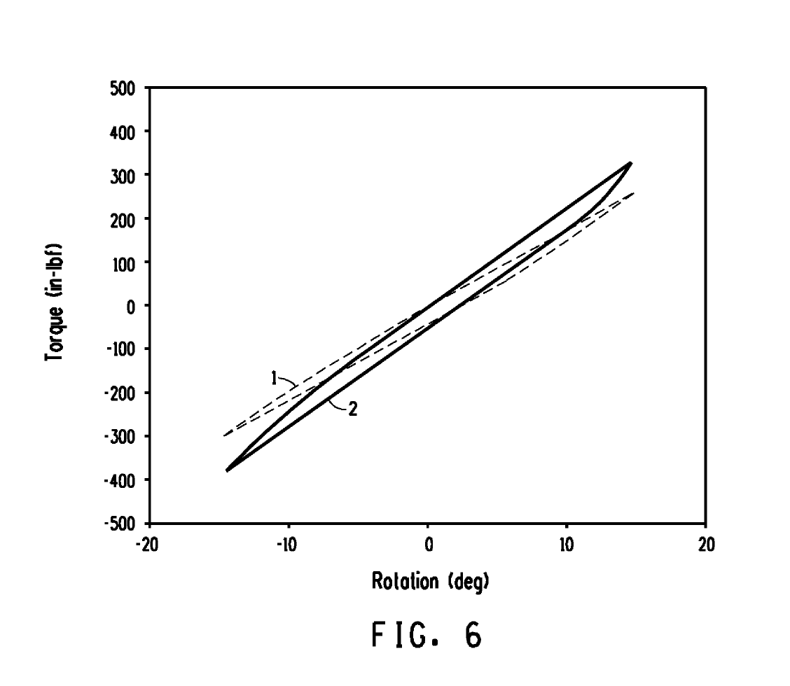

Cylinder testing is conducted substantially as follows.
1. Apply axial tension to the cylinder to prevent buckling. This axial tension simulates the tensile load in the carcass cord of an inflated full-sized tire. The amount of tension applied to the cylinder can be estimated from a tire model simulation or simply measured experimentally by determining when the cylinder would not buckle under a twisting load. FIG. 3 schematically depicts a cylinder that has undesirably buckled. For this particular cylinder, 250 lbf tensile force was sufficient to prevent buckling.
2. Once the tensile load is applied, there are two modes of testing that may be conducted to bracket the cylinder response.
   a) Mode A: The hydraulic multi-axis actuator 17 is controlled to maintain the applied load throughout the test. This means as the cylinder is twisted; the axial position will change to maintain the load. FIG. 4A shows a trace of the vertical motion of actuator 17. The horizontal axis is time and the vertical axis is displacement in inches. Since the axial load is held constant, the actuator moves up and down as the cylinder is twisted. FIGS. 4B and 4C show the torque and angular motion respectively. In FIG. 4B the vertical axis is torque in in-lbf. In FIG. 4C the vertical axis is angular rotation in degrees.
   b) Mode B: The hydraulic actuator 17 position is fixed. This means as the cylinder is twisted, the applied cylinder axial load will increase and decrease. FIG. 5A shows a trace of the load applied to actuator 17. The horizontal axis is time and the vertical axis is load in lbf. Since the axial displacement is held constant, actuator load increases and decreases as the cylinder is twisted. FIGS. 5B and 5C show the torque and angular motion, respectively. In FIG. 5B the vertical axis is torque in in-lbf. In FIG. 5C the vertical axis is angular rotation in degrees.
3. The cylinder is twisted with respect to the cylinder longitudinal axis. The angle was varied using a triangular wave form as depicted in FIG. 5C. This degree of rotation was selected to simulate conditions seen in the tire of interest based on finite element modeling or experience. For a typical passenger car tire this was ±15 degrees. These conditions could be modified to simulate other tire designs.
4. The twisting motion was repeated for twenty cycles, but the number of cycles is not intended to be limiting. The hydraulic actuator is controlled by a computer-based control system with electronic feedback. When the system is cycled in Mode A (load control), the tensile load is closed-loop feedback controlled by varying the actuator vertical position to maintain a constant axial load. When the system is operated in Mode B (displacement control) the actuator vertical position is fixed and the axial load is allowed to vary.

### EXAMPLES

Three cylinders simulating each of two different sidewall configurations were tested as provided below. One configuration, Example 1, was prepared using twisted cords typically found in tire sidewall construction. A second configuration, Example 2, was prepared using tire cords with high in-plane bending stiffness and it was believed that such cords would stiffen the tire's response to a meridinal/circumferential distortion thereby improving the tire's braking and accelerating performance.

1. A constant tensile load was selected for all cylinders being compared. This load was determined by experimentation where the axial load is increased until the cylinders did not buckle when subjected to the applied angular motion. Alternatively, a finite element model or engineering experience could have been used to determine an appropriate load.

2. The appropriate angular motion for the cylinders can be determined any of three ways. Three routes to obtain this number are (1) by tire designer experience, (2) by a tire braking or acceleration finite element model (The angle the cord makes in the tire can be translated to the appropriate cylinder angular motion through geometry), or (3) selecting a sufficiently large value such that different rubber laminates can be compared. Route 1 was used for the subject examples.

3. The test can be conducted in either Mode A “load control” or Mode B “displacement control” as described above. By conducting the test in both modes, one can bracket the cylinder response between the two extreme boundary conditions. Experience has suggested that the “load control” is the desired method. Mode B has been found to be particularly sensitive to the tensile properties of the cords for high angular displacements which is inconsistent with the tire performance. For this reason it is believed Mode A more closely approximates the boundary conditions seen in an actual tire, therefore it is the preferred method of conducting the test.

4. Once the test was complete, the data were evaluated so the performance of different cylinder constructions can be compared. First, the individual torque/angular displacement loops were extracted and averaged together to produce a single representative curve for the test. If data from multiple cylinders with the same construction are collected, these tests can be averaged together to account for slight variations between cylinders of the same construction.

5. Once the data were averaged, the angular motion was plotted on the x axis and the torque was plotted on the y axis. This produced curves shaped like a very elongated loop. The stiffer responding cylinders had loops that are more vertically oriented, while the softer responding cylinders had loops that are more horizontally oriented. The best carcass cord for braking or acceleration would be selected based on the cylinders exhibiting the stiffest response. As shown in FIG. 6, the high-stiffness tire cords of Example 2 (solid line) designed to have increased in-plane stiffness has the more vertically oriented curve opposite that of Example 1 (dashed line).

Based on the tests, tires constructed of ply layers having the most resistance to twisting (the highest meridinal/circumferential stiffness) would transfer the motion of the rim to the tire tread most effectively. This means the tire would respond quicker to braking or acceleration inputs.

1. A subscale test cylinder for testing tire performance characteristics, the cylinder having an inner diameter in the range of 3-30 inches, a length in the range of 5-60 inches and wherein the cylinder comprises components found in a tire sidewall to be simulated, wherein the components consist of cords, sidewall compounds and beads.

2. The cylinder of claim 2, wherein the inner diameter is 5.25 inches and the length is 9.00 inches.

3. A method for testing tire performance comprising,
a) providing a subscale test cylinder representative of a sidewall area in a full-sized tire,
b) placing the test cylinder in a testing device that incorporates grip assembly adapted for accepting the test cylinder,
c) applying and maintaining an axial load to the test cylinder of sufficient magnitude to avoid cylinder buckling,
d) twisting the cylinder at an angle about the cylinder's center line in the range of ±15° using a triangular wave form for a predetermined number of cycles,
e) measuring the torque and rotational displacement for the number of cycles in step (d),
f) plotting the torque and rotational displacement values to determine the stiffness performance of the subscale test cylinder.
